(19) United States
(12) Patent Application Publication
(10) Pub. No.: US 2008/0162047 A1
(43) Pub. Date: Jul. 3, 2008

(54) CROSS CORRELATION TECHNIQUE TO DELINEATE GROUNDWATER RECHARGE POTENTIAL ZONE IN HARD ROCK TERRAIN

(76) Inventors: Nepal Chandra Mondal, Andhra Pradesh (IN); Vijay Shankar Singh, Andhra Pradesh (IN)

Correspondence Address: LUEDEKA, NEELY & GRAHAM, P.C., P O BOX 1871, KNOXVILLE, TN, 37901, US

(21) Appl. No.: 11/940,338

(22) Filed: Nov. 15, 2007

(30) Foreign Application Priority Data
Jan. 3, 2007 (IN) 27/DEL/2007

(51) Int. Cl. G06F 19/00

(52) U.S. Cl. 702/2

(57) ABSTRACT

In the semi-arid region, particularly in hard rock terrain, shallow aquifers are major source of potable groundwater. These aquifers are indiscriminately exploited to meet the growing demand of water for domestic, irrigation as well as industrial use. In order to achieve a sustainable development, it is essential not only to delineate the groundwater potential zone and but also suitable augmentation scheme which in turn requires delineation of feasible recharge zone. Such zones are conventionally delineated through the application of various indirect methods such as hydro-geomorphological, geological and geophysical, which many times are time consuming and uneconomical. A simple, efficient and cost-effective cross correlation based process which takes into consideration the study of aquifer response to rainfall is provided in the present invention to delineate groundwater recharge zone.

### TECHNICAL FIELD

The present invention relates to a process for delineating ground water recharge zone. More particularly, the present invention relates to a process involving cross-correlation for delineating ground water recharge zone, thereby detecting a potential ground water recharge zone, in hard rock terrain.

### BACKGROUND AND PRIOR ART OF THE INVENTION

In many countries, particularly in Asia, there has been rapid development in various fields, particularly in agriculture and industry, during last couple of decades. This has lead to ever increasing demand for groundwater to meet the requirement of domestic, agriculture and industry. Such demands are met with indiscriminate exploitation of groundwater. The only source of replenishment of this exploited resource is rainfall, which is limited to few monsoon months in a year, particularly, in semi arid regions of countries like India. According to an estimate contained in the report entitled “Annual Replenishable Ground water Potential of India—An Estimate based on injected tritium studies, Rangarajan R. and Athavale R. N., Jour. of Hydrology, Vol. 234, (2000), pp. 38-53”, there is about 4.1 to 19.7 percent of annual rainfall that replenishes groundwater in semi arid regions. The annual rainfall in the semi arid region is often scanty and recurring drought often prevails. The over exploitation of groundwater in such situations lead to progressive depletion of its potential resulting in a consequence progressive decline in groundwater level year after year. In order to arrest the depletion in groundwater potential and to achieve sustainable development, several measures including artificial groundwater recharge are suggested. Various methodologies of artificial recharge are suggested in the paper entitled “Various Methodologies of Artificial Recharge for Sustainable Groundwater in Quantity and Quality for Developing Water Supply Schemes” by Muralidharan D. and Shanker G. B. K., in Proc. All Indian Seminar on Water Vision for 21^{st} Century, IAH, Jadavpur University, Kolkata, p. 208-229 (2000). Yet another measure is suggested by Bouwer, H. in his paper entitled “Artificial recharge of groundwater: hydrogeology and engineering” in the Hydrogeology Journal, Vol. 10 (1): 121-142, 2002 and still another measure is suggested by Lerner, D. N. in his paper entitled “Identification and quantifying urban recharge: a review” in the Hydrogeology Journal, Vol. 10. (1): 143-152 (2002).

In order to implement artificial groundwater recharge, it is essential to delineate or in simpler words define potential groundwater recharge zones. Conventionally, piston-flow model, remote sensing, photogeological, hydrogeological, geophysical methods and regional groundwater model are deployed to select favorable or potential zones for implementation of artificial recharge scheme (Zimmermann et al 1967 (Zimmermann, U., Munnich, O. K. and Roether, W.—Downward movement of soil moisture traced by means of hydrogen isotopes. American Geophysical Monograph, 1967, 11, pp. 28-36), Munnich, 1968 (Munnich, O. K.—Moisture movement measured by isotope tagging; In: Guide Book on Nuclear Techniques in Hydrology, IAEA, Vienna, 1968, pp. 112-117), Athavale et al, 1980 (Athavale, R. N., Murti, C. S. and Chand, R.—Estimation of recharge to phreatic aquifers of Lower Maner Basin by using the Tritium injection method. Journal of Hydrology, Vol. 45, 1980, pp. 185-202); Athavale et al, 1983 (Athavale, R. N., Chand, R. and Rangarajan, R.—Ground water recharge estimates for two basin in the Decccan Trap Basalt formation, Hydrological Sciences Journal, 28, 4, 12, 1983, pp. 525-538), Athavale et al, 1992 (Athavale, R. N., Rangarajan, R. and Murlidharan, D.—Measurement of natural recharge in India, Jourl. Geol. Society of India, Vol. 39, 1992, pp 235-244), Athavale et al, 1998 (Athavale, R. N., Rangarajan, R., Muralidharan, D.,—Influx and efflux of moisture in a desert soil during a one-year period. Water Resour. Res. 34 (110), 1998, 2871-2877); Gupta and Sharma, 1984 (Gupta, S. K., and Sharma, S. C.—Soil moisture transport through the unsaturated zone. Tritium tagging studies in Sabarmati basin West India, Hydrl. Sci. J. 29 (2), 1984, 177-189); Scanlon et al. 2002 (Scanlon, B. R, Healy, R. W. and Cook, P. G.—Choosing appropriate techniques for quantifying groundwater recharge, Hydrogeology Journal, Vol. 10 (1), 2002, 18-39) and Jackson, 2002 (Jackson, T. J.—Remote sensing of soil moisture: implications for groundwater recharge, Hydrogeology Journal, Vol. 10 (1), 2002, 40-51)).

Thus, it can be said that delineation of groundwater recharge zone and detection of potential ground water recharge zones are vital to augment groundwater resources. Although the process of delineating the ground water recharge zone and detection of potential ground water recharge zone are important in all types of zones, they are essential for sustainable development of ground water resources in semi arid zones, such as, for example, hard rock terrains because of the restriction on the available water resource for implementation of the artificial groundwater recharge.

Development of groundwater management tool also needs this vital knowledge. Conventionally, suitable zone for artificial recharge is deciphered using hydro-geological, geo-physical and geo-morphological maps, which is often time consuming and uneconomical. Therefore, the analysis of unconfined aquifer response in terms of rise in water level due to precipitation, a rapid and cost-effective technique is evolved.

These methods are time consuming and some times uneconomical, particularly, when one has to deal with large basin. Instead, one can adopt simple and rapid method to scan the entire area and arrive at suitable zone, where detail study can be taken up.

### OBJECTS OF THE INVENTION

The first object of the present invention is to delineate ground water recharge zone using a cross correlation technique.

The second object of the present invention is to detect a potential ground water recharge zone in an area using a cross correlation technique.

### SUMMARY OF THE INVENTION

Accordingly, the present invention provides a process for delineating a ground water recharge zone, the said process comprising the steps of locating a potential ground water recharge zone in an area, then obtaining water level depth data and rainfall data for one or more ground water recharge zones for two or more periods of time, determining cross correlation co-efficient (C) between the rainfall data and the water level depth data for each of the said ground water recharge zones, followed by detecting the ground water recharge zone having value of the cross correlation co-efficient (C), above a predetermined value as a potential ground water recharge zone, and classifying the ground water recharge zone as one of: high recharge zone; moderate recharge zone; low recharge zone; and poor recharge zone, depending upon the value of the cross correlation co-efficient thus obtained.

In an embodiment of the present invention, the cross correlation co-efficient (C) is defined as:

$$C = \frac{\sum RD}{n {σ}_{r} {σ}_{d}}$$

wherein:
r is the actual rainfall for the selected period of time;
r′ is the mean of the rainfall;
d is the actual depth of water level for the selected period of time;
d′ is the mean of the depth of water level;
σᵣ is the standard deviation of r-series;
σ_{d} is the standard deviation of the d-series;
R is the deviation from the mean r=(r−r′)
D is the deviation from the mean d=(d−d′)
n is the number of data set of depth to water level corresponding to rainfall.

In another embodiment of the present invention, if the study area is a semi-arid zone, the ground water recharge zone is classified as high recharge zone if cross correlation co-efficient (C) is greater than about 0.60.

In yet another embodiment of the present invention, if the study area is a semi-arid zone, the ground water recharge zone is classified as moderate recharge zone if cross correlation co-efficient (C) lies in the range of preferably 0.50 to 0.60.

In a further embodiment of the present invention, if the study area is a semi-arid zone, the ground water recharge zone is classified as low recharge zone if cross correlation co-efficient (C) is in the range of preferably 0.40 to 0.50.

In another embodiment of the present invention, if the study area is a semi-arid zone, the ground water recharge zone is classified as poor recharge zone if cross correlation co-efficient (C) is lesser than about 0.40.

In yet another embodiment of the present invention, the depth of water level is obtained after a lapse of a predetermined period of time calculated from the rainfall.

In a further embodiment of the present invention, the depth of water level is obtained after a lapse of about 15 days to 150 days from the rainfall.

The results obtained by following the process of the present invention is cross checked with the results achieved from Remote Sensing (RS) studies and GIS studies for the study area to determine the workability and accuracy of the presently claimed method.

The following paragraphs are provided in order to describe the best mode of working the invention.

### BRIEF DESCRIPTION OF THE ACCOMPANYING DRAWINGS

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 represents the location of the rain-gauge station, monitoring of wells and drainage pattern in the study area.

FIG. 2 represents the plot of cross correlation coefficient in different lag in each of the monitoring wells.

FIG. 3 represents the qualitative recharge zone through correlation co-efficient which matched with the results achieved from RS and GIS techniques.

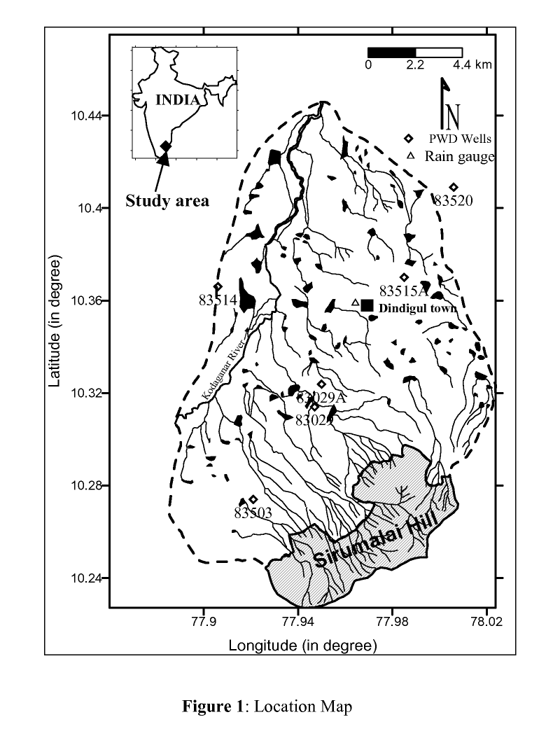

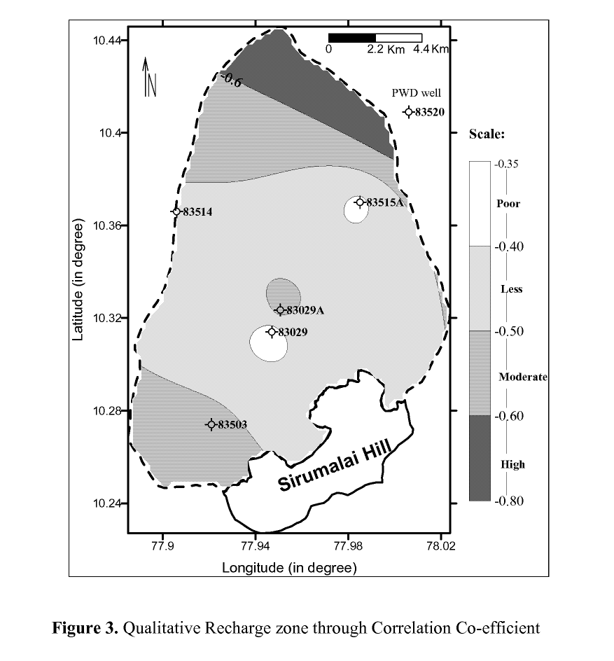

The elements in the drawings are illustrated for simplicity and have not necessarily been drawn to scale. For example, the map of the geographical region shown in FIGS. 1 and 3 may be exaggerated relative to other elements to help to improve understanding of embodiments of the present invention.

### DETAILED DESCRIPTION OF THE INVENTION

The present invention provides a cross-correlation technique for delineating ground water recharge zone, the said process comprising the steps of:
(a) measuring or collecting or obtaining water level depth data and rainfall data for a ground water recharge zone for two or more period of time in a study area;
(b) determining cross correlation co-efficient (C) between the rainfall data and the water level depth data; and
(c) classifying the ground water recharge zone as one of:
   (i) high recharge zone;
   (ii) moderate recharge zone;
   (iii) low recharge zone; and
   (iv) poor recharge zone depending upon the value of the cross correlation co-efficient thus obtained in step (b).

The depth of water level is obtained after a lapse of about 15 days to 150 days from the rainfall. Also, the present invention provides a process for detecting a potential ground water recharge zone in an area, the said process comprising the steps of:
(a) measuring or collecting or obtaining water level depth data and rainfall data for one or more ground water recharge zones located in the area for two or more periods of time;
(b) determining cross correlation co-efficient (C) between the rainfall data and the water level depth data for each of the said ground water recharge zones; and
(c) detecting the ground water recharge zone having value of the cross correlation co-efficient (C) above a predetermined value as a potential ground water recharge zone.

The cross correlation co-efficient (C) is defined as:

$$C = \frac{\sum RD}{n {σ}_{r} {σ}_{d}}$$

wherein:
r is the actual rainfall for the selected period of time;
r′ is the mean of the rainfall;
d is the actual depth of water level for the selected period of time;
d′ is the mean of the depth of water level;
σᵣ is the standard deviation of r-series;
σ_{d} is the standard deviation of the d-series;
R is the deviation from the mean r=(r−r′)
D is the deviation from the mean d=(d−d′)
n is the number of data set of depth to water level corresponding to rainfall.

### DETAILED DESCRIPTION OF THE EMBODIMENTS

In semi arid region where groundwater occurs in shallow weathered zones, the rise in groundwater level is a direct consequence of precipitation in particular during monsoon season, when the groundwater withdrawal is minimum. The rise of water level at a particular place is a characteristic feature of unsaturated zone (Athavale et al 1992). Therefore, there exists a definite relationship between amount of rise in water level and precipitation for a particular region. In other words each zone is characterized by a parameter that correlates rise in groundwater level with precipitation. Higher correlation coefficient implies significant groundwater recharge characteristic or a favorable recharge zone. Considering this fact, rise in groundwater level and rainfall data from an area in semi arid region have been analyzed to delineate suitable artificial recharge zone. The monthly water level data recorded by Public Works Department (PWD), Tamilnadu, India, in 6 monitoring wells in the study area for 31 years (from March 1971 to February 2002) have been considered for the analysis. The data of this study is available in “Groundwater Perspectives: A profile of Dindigul District, Tamilnadu” PWD, Govt. of India, Chennai-600005, Report, (2000), pp-78. The cross-correlation between rainfall and depth to water level measured in different months from March 1971 to February 2002 had been determined. The correlation coefficient of these two parameters varies from place to place and time to time. It has been found that there has been significant rise in water level due to rain in the month of October to January. An attempt was therefore made to correlate the water level variation due to the monsoon rainfall during the months of October to January and the correlation values have been compared with the results of Remote Sensing (RS) and Geographical Information System (GIS).

The following example is given by way of illustration and therefore should not be construed to limit the scope of the present invention:

### EXAMPLE

To start with, pluralities of ground water recharge zones are selected in the study area. Six monitoring wells in the study area (Dindigul District, Tamilnadu, India), marked in FIGS. 1 and 3 as 83503, 83029, 83514, 83515A, 83520 and 83029A are considered. The monthly water level data recorded by Public Works Department (PWD), Tamilnadu, India, in the said 6 monitoring wells in the study area for 31 years (from March 1971 to February 2002) have been considered for the analysis. The cross-correlation between rainfall and depth to water level measured in different months from March 1971 to February 2002 had been determined.

It was noticed that the water level of unconfined aquifer in the study area with rainfall data responds after one/two months lag of rainfall. The cross correlation co-efficient were determined between depth of water table and corresponding rainfall. The results of correlation coefficients are shown in Table-1.

In the table(s) accompanying the following specification,

Table-1 represents the cross correlation matrix between depth of water table and rainfall in different lags, and
Table-2 represents the correlation matrix corresponding lags in PWD wells.

TABLE 1
Cross correlation matrix in between depth of water table
and rainfall in different lags

| | Well no. | | | | | |
|---|---|---|---|---|---|---|
| | 83029 | 83029A | 83503 | 83514 | 83515A | 83520 |
| Without lag | 0.09 | 0.16 | 0.05 | 0.13 | 0.03 | 0.12 |
| 1-month lag | 0.15 | 0.23 | 0.14 | 0.20 | 0.04 | 0.24 |
| 2-month lag | 0.16 | 0.25 | 0.12 | 0.17 | 0.01 | 0.24 |
| 3-month lag | 0.12 | 0.20 | 0.11 | 0.09 | 0.001 | 0.21 |
| 4-month lag | 0.10 | 0.18 | 0.11 | 0.04 | 0.01 | 0.17 |

It clearly indicates that the wells nos. 83029 and 83029A are responding with two months lag after the rainfall with values of 0.16 and 0.25, where as well nos. 83503, 83514, 83515A and 83520 are in one-month lag of the rainfall with values of 0.14, 0.20, 0.04 and 0.24 respectively. The location of wells is shown in FIG. 1. The correlation coefficient values are plotted corresponding to lag of water table rises. This plot indicates that wells 83503, 83514, 83515A and 83520 responds after one month rainfall whereas wells 83029 and 83029A respond in two month lag.

By applying the cross-correlation technique to water tables variation in response to rainfall the following observations have been made.
The time lags of 1-month and 2-month for the response of the aquifer after rainfall.
The amplitude of correlation decreases, when lag increases/decreases in systematic manner.
The depth of the aquifer also plays important role for the delay, because of subsurface losses as well as travel time for vertical percolation. The travel time may vary from a few minutes for shallow water tables in permeable formations to several months or years for deep water tables underlying sediments or weathered zones with low vertical permeability.

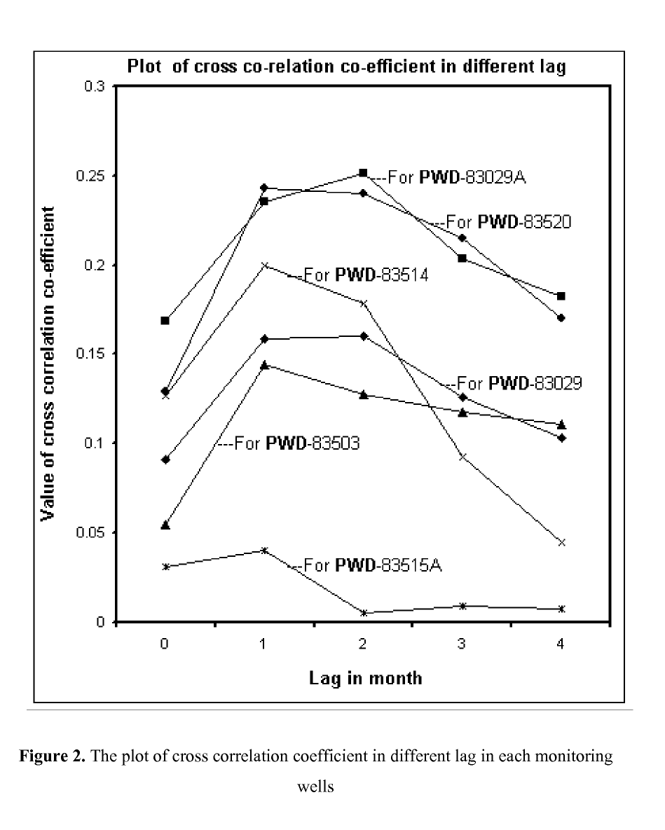

The qualitative estimation of recharge zone is made on the basis of cross correlation coefficient values. The cross correlation coefficient values from September to March (wet period) with corresponding response lags are represented in the Table-2 and taking the maximum recharge coefficients, plotted in FIG. 2.

TABLE 2
Correlation Matrix corresponding lags in PWD wells

| | 83029 | 83029A | 83503 | 83514 | 83515A | 83520 |
|---|---|---|---|---|---|---|
| | 2-month | 2-month | 1-month | 1-month | 1-month | 1-month |
| Months | lag | lag | lag | lag | lag | lag |
| September | −0.09 | −0.12 | −0.14 | −0.19 | −0.14 | −0.09 |
| October | −0.23 | −0.53 | −0.41 | −0.29 | −0.12 | −0.26 |
| November | −0.32 | −0.48 | −0.53 | −0.48 | −0.24 | −0.80 |
| December | −0.35 | −0.41 | −0.36 | −0.11 | −0.35 | −0.37 |
| January | −0.34 | −0.40 | −0.19 | −0.31 | −0.37 | −0.24 |
| February | −0.30 | −0.37 | −0.24 | −0.24 | −0.16 | −0.15 |
| March | −0.03 | −0.03 | −0.19 | −0.14 | −0.06 | −0.15 |

High value of correlation coefficient indicates that the region gets more recharge and low value indicates that recharge is poor. Due to the rainfall in the month of October PWD well 83029A is getting response in December. The value of correlation coefficient is 0.53. The PWD wells 83503, 83514 and 83520 are responding during December due to the rainfall in November. The correlation values of these wells are −0.53, −0.48 and −0.80 respectively. But in the well 83029 depths of water levels were getting low in February due to the rainfall in December. −0.35 is the maximum correlation value in this well. On the other hand, the well 83515A is giving good response due to the rainfall in January. The value is −0.37. The above correlation values indicate the behavior of the recharge response of the unconfined aquifer in the study area.

Institute of Remote Sensing (IRS, 2000), Anna University, Chennai-600 025, (Personnel communication (2000): Identification of groundwater recharge areas using RS and GIS by Institute of Remote Sensing, Anna University, Chennai-600025, India) has divided the study area into four recharge areas using Remote Sensing (data) and GIS. They are (1) High, (2) Moderate, (3) Less and (4) Poor zones for recharge. On the basis of high correlation coefficient the entire region is divided into four recharge zones qualitatively as shown in FIG. 3, which is in good agreement with the result of GIS and Remote Sensing technique. These are

Zones of highly recharge for value of (C>0.60)

Moderate zone for recharge (0.50≦C≧0.60)

Zones of less recharge (0.40≦C≧0.50) and

Zones of poor recharge (C<0.40).

The water table hydrographs against the rainfall show one/two-months time lag. It has also been observed that aquifer responds significantly to the rainfall during October to January of each year due to monsoon rains. It is based on general principle, which is an independent variable rainfall (r) and a dependent variable depth to water level (d) with one/more months lag to rainfall are plotted. Considering the mean of rainfall (r′) and depth to water level (d′), origin may shift to point (r′, d′). Hence, the new co-ordinate may be defined as R(=r−r′) and D(=d−d′). Thus the correlation co-efficient (C) is defined as:

$$C = \frac{\sum RD}{n {σ}_{r} {σ}_{d}}$$

### Where,

R=Deviation from the mean r(=r−r′)

D=Deviation from the mean d(=d−d′)

σᵣ=Standard deviation of r-series

σ_{d}=Standard Deviation of d-series and

n=Number of data set of depth to water level corresponding to rainfall.

The results and the classification shown above are provided by way of exemplification only.

Although, the results and the classification shown above by way of exemplification are pertaining to Dindigul District, Tamilnnadu, India, it is believed that the results and the classification to other semi arid zones. However, it would be clear to a person skilled in the art that the method of the present application can be applied to all types of zones. If the method is applied to other types of regions/zones, which are not semi arid in nature, the classification of the groundwater recharge zone as one of:

(i) high recharge zone;
(ii) moderate recharge zone;
(iii) low recharge zone; and
(iv) poor recharge zone would depend upon the value of the cross correlation co-efficient which is prevailing in that region.

### ADVANTAGES OF THE INVENTION

The main advantages of the present cross correlation technique are:
1. It is easy and cost effective to delineate the groundwater recharge zone in the study area using the process of the present invention.
2. The process of the present invention enables to cover large area which is difficult and time consuming by the existing methods (i.e. by adopting the methods taught by Zimmermann et al. 1967; Munnich, 1968, Athavale et al, 1980, 1983, 1992, 1998; Muralidharan et al 2000 and Gupta and Sharma, 1984) and,
3. By adopting the process of the present invention, it is possible to easily demarcate the possible quantitative groundwater recharge zones at a glance.

1. A process for delineating a ground water recharge zone, the said process comprising the steps of:
(a) locating a potential ground water recharge zone in an area,
(b) obtaining water level depth data and rainfall data for one or more ground water recharge zones as located in step (a), for two or more periods of time,
(c) determining cross correlation co-efficient (C) between the rainfall data and the water level depth data as obtained in step (b), for each of the said ground water recharge zones as obtained in step (a),
(d) detecting the ground water recharge zone having value of the cross correlation co-efficient (C), determined in step (c), above a predetermined value as a potential ground water recharge zone,
(e) classifying the ground water recharge zone as one of:
(i) high recharge zone;
(ii) moderate recharge zone;
(iii) low recharge zone; and
(iv) poor recharge zone depending upon the value of the cross correlation co-efficient thus obtained in step (d).

2. The process according to claim 1, wherein the cross correlation co-efficient (C) is defined as:
$$C = \frac{\sum RD}{n {σ}_{r} {σ}_{d}}$$
wherein:
r is the actual rainfall for the selected period of time;
r′ is the mean of the rainfall;
d is the actual depth of water level for the selected period of time;
d′ is the mean of the depth of water level;
σᵣ is the standard deviation of r-series;
σ_{d} is the standard deviation of the d-series;
R is the deviation from the mean r=(r−r′)
D is the deviation from the mean d=(d−d′)
n is the number of data set of depth to water level corresponding to rainfall.

3. The process according to claim 1 wherein, if the study area is a semi-arid zone, the ground water recharge zone is classified as high recharge zone if cross correlation co-efficient (C) is greater than about 0.60.

4. The process according to claim 1 wherein, if the study area is a semi-arid zone, the ground water recharge zone is classified as moderate recharge zone if cross correlation co-efficient (C) lies in the range of preferably from 0.50 to 0.60.

5. The process according to claim 1 wherein, if the study area is a semi-arid zone, the ground water recharge zone is classified as low recharge zone if cross correlation co-efficient (C) is in the range of preferably from 0.40 to 0.50.

6. The process according to claim 1 wherein, if the study area is a semi-arid zone, the ground water recharge zone is classified as poor recharge zone if cross correlation co-efficient (C) is lesser than about 0.40.

7. The process according to claim 1 wherein, the depth of water level is obtained after a lapse of a predetermined period of time calculated from the rainfall.

8. The process according to claim 1 wherein, the depth of water level is obtained after a lapse of about 15 days to 150 days from the rainfall.
